(19) United States
(12) Patent Application Publication
(10) Pub. No.: US 2016/0253019 A1
(43) Pub. Date: Sep. 1, 2016

(54) TOUCH SYSTEMS AND METHODS EMPLOYING FORCE DIRECTION DETERMINATION

(71) Applicant: 3M INNOVATIVE PROPERTIES COMPANY, Saint Paul, MN (US)

(72) Inventor: Bernard O. Geaghan, Salem, NH (US)

(21) Appl. No.: 15/021,276

(22) PCT Filed: Nov. 5, 2014
(86) PCT No.: PCT/US2014/064012

§ 371 Date: Mar. 11, 2016

Related U.S. Application Data
(60) Provisional application No. 61/907,360, filed on Nov. 21, 2013.

(51) Int. Cl. G06F 3/041; G06F 3/044

(52) U.S. Cl. CPC G06F 3/0414; G06F 3/044

(57) ABSTRACT

A touch sensor comprises first and second patterned conductive traces, and an optically clear layer disposed between the first and second patterned conductive traces. The touch sensor is configured to determine a direction of a force applied to the touch sensor by determining an anisotropic change in a characteristic of the applied force.

### TECHNICAL FIELD

This disclosure relates generally to touch-sensitive devices, particularly those that rely on contact between a user's finger or other touch implement and the touch device.

### BACKGROUND

Touch-sensitive devices allow a user to conveniently interface with electronic systems and displays by reducing or eliminating the need for mechanical buttons, keypads, keyboards, and pointing devices. For example, a user can carry out a complicated sequence of instructions simply by touching an on-display touch screen at a location identified by an icon.

### BRIEF SUMMARY

Embodiments of the disclosure are directed to a touch sensor comprising first and second patterned conductive traces, and an optically clear layer disposed between the first and second patterned conductive traces. The touch sensor is configured to determine a direction of a force applied to the touch sensor by determining an anisotropic change in a characteristic of the applied force.

Various embodiments are directed to an apparatus comprising a touch sensor having a touch surface. The touch sensor is configured to electronically sense for elastic localized deformation at a touch location of the touch surface in response to a force applied thereto, the elastic localized deformation at the touch location having a three-dimensional shape. A processor is coupled to the touch sensor. The processor is configured to electronically determine a direction of a non-perpendicular force applied at the touch location based on the shape of the localized deformation at the touch location.

Some embodiments are directed to an apparatus comprising a touch sensor having a touch surface. The touch sensor is configured to sense localized depression and protrusion of the touch surface at the touch location in response to a non-perpendicular force applied thereto. A processor is coupled to the touch sensor. The processor is configured to determine a direction of the non-perpendicular force based on the localized depression and protrusion of the touch surface at the touch location.

Other embodiments are directed to a method comprising sensing a non-perpendicular force applied to a touch surface of a touch sensor, and sensing an anisotropic change in a characteristic of the applied force. The method also comprises determining a direction of the applied force based on the anisotropic change in the applied force characteristic.

Certain embodiments are directed to a method comprising sensing for a touch force applied at a touch location on a touch surface of a touch sensor, and sensing for elastic localized deformation at the touch location in response to the applied force, the localized deformation having a 3-dimensional shape. The method also comprises electronically determining a direction of a non-perpendicular force applied at the touch location based on the shape of the localized deformation.

Further embodiments are directed to a method comprising sensing for a touch force applied at a touch location on a touch surface of a touch sensor, and sensing for localized depression and protrusion of the touch surface at the touch location in response to a non-perpendicular force applied at the touch location. The method also comprises determining a direction of the non-perpendicular force applied at the touch location based on the localized depression and protrusion of the touch surface at the touch location.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF DRAWINGS

FIG. 1 shows a representative touch sensor communicatively coupled to a processor in accordance with various embodiments of the disclosure;

FIGS. 2-4 are exaggerated views of a region of a touch surface of a touch sensor subject to elastic localized deformation in accordance with various embodiments of the disclosure;

FIGS. 5-7 are flow diagrams of various methodologies for determining a direction of a non-perpendicular force applied to a touch sensor in accordance with various embodiments of the disclosure;

FIG. 8 is a sectional view of a capacitive touch sensor in accordance with various embodiments;

FIG. 9 is a sectional view of a resistive touch sensor in accordance with various embodiments;

FIG. 10 is a sectional view of a touch sensor comprising a force sensing material in accordance with various embodiments;

FIG. 11 is a sectional view of a piezoelectric touch sensor in accordance with various embodiments;

FIG. 12 is a sectional view of a touch sensor comprising an optical waveguide configured to sense an non-perpendicular force using frustrated total internal reflection in accordance with various embodiments;

FIG. 13 illustrates a region of localized elastic deformation of the deformable optical waveguide shown in FIG. 12 in response to application of a touch force in accordance with various embodiments;

FIG. 14 illustrates virtual objects presented on a touch sensitive display that can be manipulated by a user in accordance with various embodiments; and

FIG. 15 illustrates a virtual control that operates as a slider or fader in accordance with various embodiments.

### DETAILED DESCRIPTION OF ILLUSTRATIVE EMBODIMENTS

Embodiments of the disclosure are directed to sensing a force applied to a touch sensor and determining a direction of the force applied to the touch sensor. Some embodiments are directed to determining the direction of a force applied to the touch sensor and a magnitude of the applied force. Other embodiments are directed to determining a direction of the force applied to the touch sensor, a magnitude of the applied force, and a location of the applied force. Embodiments of the disclosure may include any or a combination of a variety of touch sensor technologies, including capacitive, resistive, force, optical, infrared, frustrated total internal reflection, electromagnetic, surface acoustic wave, acoustic pulse, bending waves, signal dispersion, and near field imaging, among others.

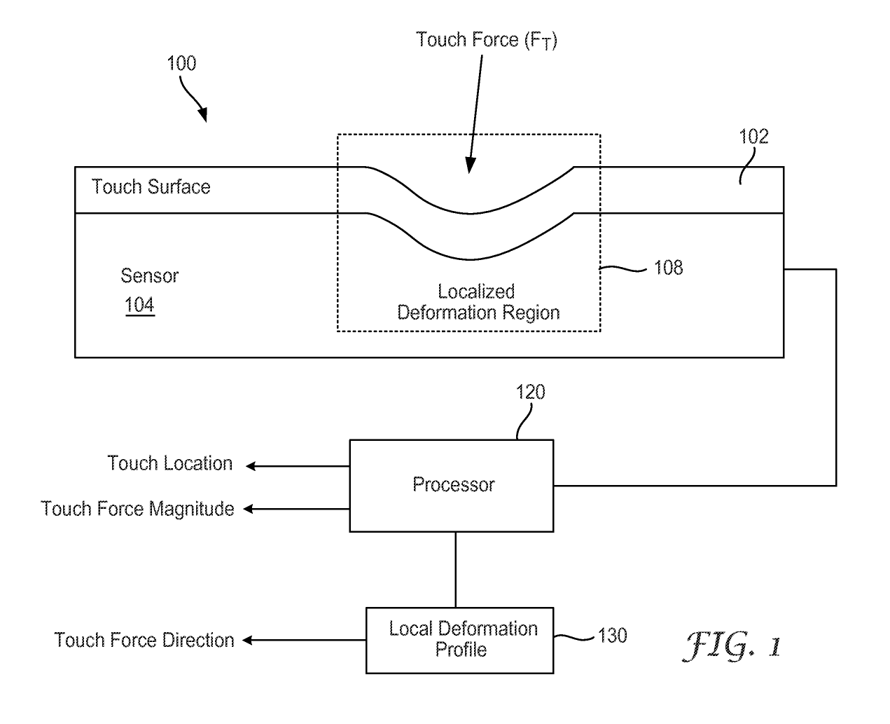

FIG. 1 shows a representative touch sensor 100 communicatively coupled to a processor 120. The touch sensor 100 includes a touch surface 102 and a sensor 104 adjacent the touch surface 102. According to various embodiments, the touch surface 102 elastically deforms at a localized region 108 of the touch surface 102 in response to a touch force, F_{T}, applied thereto. Portions of the touch surface 102 remote from the localized deformation region 108 remain undisturbed from the touch event at the touch location. As is illustrated in FIG. 1, a touch force, F_{T}, causes localized elastic deformation of the touch surface 102 within a region 108 at and neighboring the touch location, resulting in a three-dimensional distortion of the touch surface 102 at the touch location. This three-dimensional distortion of the touch surface 102 caused by the touch force, F_{T}, changes in shape and size dynamically in responses to changes of the touch force, F_{T}, over time (e.g., during a gesture). More particularly, the elastic deformation at the localized region 108 of the touch surface 102 changes over time in terms of area (x and y directions in the plane of touch surface 102) and in depth/height (z direction normal to the plane of touch surface 102) in proportion to the magnitude and direction of the applied touch force, F_{T}. Upon removal of touch force, F_{T}, the localized deformation region 108 of the touch surface 102 returns to its original location, shape, and size.

According to some embodiments, the sensor 104 is configured to electronically sense for elastic localized deformation of the touch surface 102 at a touch location of the touch surface 102 in response to a force applied thereto. This elastic localized deformation at the touch location has a three-dimensional shape. The processor 120, coupled to the touch sensor 100, is configured to electronically determine a direction of a non-perpendicular force applied at the touch location based on the shape of the localized deformation region 108 at the touch location. For example, the processor 120 is configured to receive signals from the sensor 104 and generate a local deformation profile 130 in response to localized deformation of the touch surface 102 resulting from application of a touch force, F_{T}. The processor 120 uses the local deformation profile 130 to determine the direction of the touch force, F_{T}, applied to the touch surface 102. The processor 120 may also be configured to determine the magnitude of the touch force, F_{T}, and may further be configured to determine the touch location on the touch surface 102.

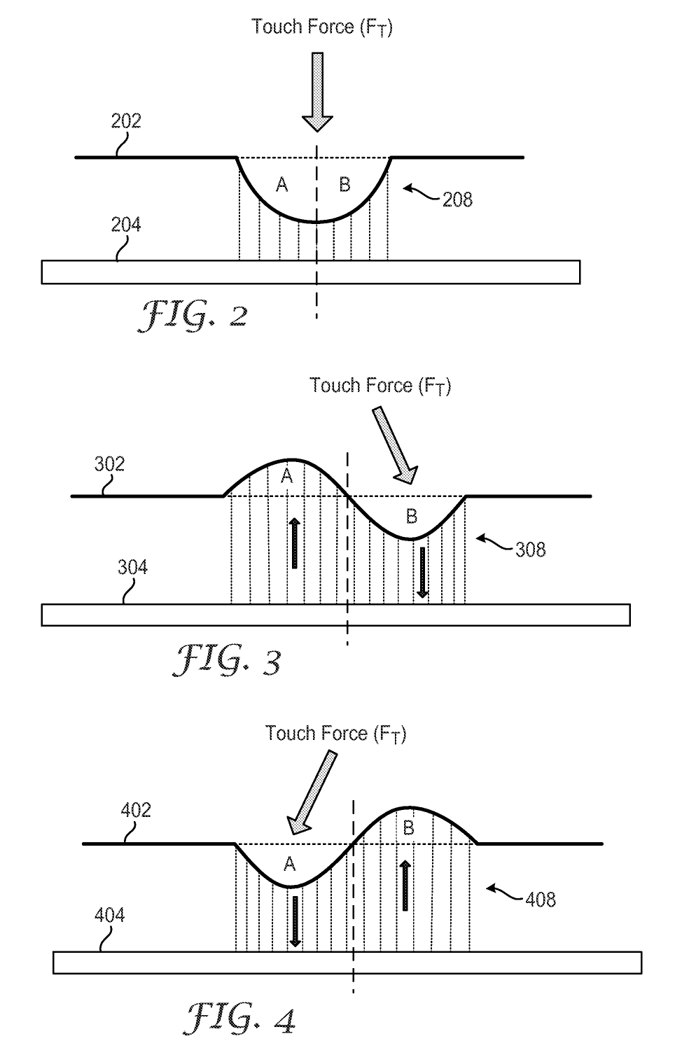

According to various embodiments, the deformation resulting from application of a touch force, F_{T}, involves elastic localized deformation of at least two substantially parallel major surfaces (shown in other figures) of the touch sensor 100. In other embodiments, the deformation resulting from application of a touch force, F_{T}, involves elastic localized deformation of only one major surface of the touch sensor 100. As will be discussed in greater detail with reference to FIGS. 2-4, and in accordance with some embodiments, the touch sensor 100 can be configured to sense a first force component directed into the touch surface 102 at or near the touch location and a second force component directed out of the touch surface 102 at or near the touch location. The processor 120 can be configured to determine the direction of the non-perpendicular force applied to the touch surface 102 using the first and second force components.

According to some embodiments, the touch sensor 100 comprises a capacitive sensor 104 configured to map the shape of the elastic localized deformation 108 at the touch location. In other embodiments, the touch sensor 100 comprises a resistive sensor 104 configured to map the shape of the elastic localized deformation 108 at the touch location. In further embodiments, the touch sensor 100 comprises an optical sensor 104 configured to map the shape of the elastic localized deformation 108 at the touch location. In certain embodiments, the touch sensor 100 comprises a piezoelectric electric sensor 104 configured to map the shape of the elastic deformation 108 at the touch location.

In accordance with some embodiments, the touch sensor 100 includes first and second patterned conductive traces (shown in other figures), and an optically clear layer disposed between the first and second patterned conductive traces. The touch sensor 100 is configured to determine a direction of a force, F_{T}, applied to the touch surface 102 by determining an anisotropic change in a characteristic of the applied force. For example, the processor 120 can be configured to determine an anisotropic change in a contact area between the sensor 104 and the applied force, F_{T}. By way of further example, as the force, F_{T}, is applied to the touch surface 102 along a direction oblique to the plane of the touch surface 102, the contact area changes anisotropically along the oblique direction projected onto the touch surface 102, which can be determined by the processor 120. The processor 120 may determine the direction of the force, F_{T}, applied to the touch surface 102 based on the determined anisotropic changes in the contact area.

According to some embodiments, the processor 120 is configured to determine a direction of the force, F_{T}, applied to the touch surface 102 by determining an anisotropic change in capacitance in the sensor 104 proportional to the applied force, F_{T}. For example, as the force, F_{T}, is applied to the touch surface 102 along an oblique direction, capacitances in the sensor 104 increase along the oblique direction projected onto the touch surface 102. The processor 120 may determine the direction of the force, F_{T}, applied to the touch surface 102 based on the determined anisotropic changes in the capacitances.

In some embodiments, the processor 120 is configured to determine a magnitude of the force, F_{T}, applied to the touch surface 102 by determining an anisotropic change in a characteristic of the applied force. In other embodiments, the processor 120 is configured to determine a direction of a force, F_{T}, applied to the touch surface 102 by determining an anisotropic change in a characteristic of an optically clear layer of the touch sensor 100. For example, the processor 120 may be configured to determine a direction of a force, F_{T}, applied to the touch surface 102 by determining an anisotropic change in local thickness of the optically clear layer of the touch sensor 100 in response to the applied force, F_{T}.

FIGS. 2-4 are exaggerated views of a region of a touch surface of a touch sensor subject to elastic localized deformation in accordance with various embodiments of the disclosure. FIG. 2 shows a touch surface 202 of the touch sensor and deformation of the touch surface 202 resulting from a touch force, F_{T}, applied thereto. In FIG. 2, the touch force, F_{T}, is applied in a direction perpendicular to the touch surface 202. Application of the touch force, F_{T}, to the touch surface 202 causes elastic localized deformation 208 at the touch location. Although shown in cross section in FIG. 2, the localized deformation 208 has a three-dimensional shape. Because the touch force, F_{T}, is applied in a direction normal to the touch surface 202, the elastic localized deformation 208 has a relatively uniform bowl shape. As such, the volumes A and B of the deformation 208 are substantially symmetrical with respect to the dashed line shown in FIG. 2. Based on the relative symmetry of the localized deformation 208, the sensor 204 determines that the direction of the touch force, F_{T}, is normal to the touch surface 202.

The sensor 204 is configured to determine a shape or profile of the localized deformation 208. Each of the dotted lines extending vertically between the sensor 204 and periphery of the localized deformation 208 represents a measurement made by the sensor 204. The type of measurement is dependent on the technology of the sensor 204. For example, the measurement made by the sensor 204 can be based on capacitance, resistance, voltage or current change, force, light intensity, or a combination of any of these parameters. The number of measurements and spacing between measurements made by the sensor 204 can be adjusted to achieve a desired sensing resolution.

FIG. 3 shows a non-perpendicular touch force, F_{T}, applied to a touch surface 302 of a touch sensor. Application of the touch force, F_{T}, to the touch surface 302 causes asymmetrical, elastic localized deformation 308 of the touch surface 302 at the touch location. In particular, application of the touch force, F_{T}, at an oblique angle to the touch surface 302 creates a localized depression, B, and a localized protrusion, A, of the touch surface 302 at the touch location. The sensor 304 makes measurements at the touch location of the touch surface 302 to determine the shape or profile of the localized depression, B, and protrusion, A. Based on the measurements, the sensor 304 or a processor coupled to the sensor 304 can determine the direction of the non-perpendicular force, F_{T}. According to the simplified example illustrated in FIG. 3, the sensor 304 can determine that the localized depression, B, is on the right side of the dashed line relative to the localized protrusion, A. Based on the relative locations of the localized depression, B, and protrusion, A, at the touch location, the sensor 304 or processor coupled thereto can determine that the non-perpendicular touch force, F_{T}, is oriented in a direction toward the bottom of the localized depression, B, and away from the peak of the localized protrusion, A. A more detailed analysis of the topography of the deformation profile at the touch location (e.g., calculating the gradient of a topographic mapping of the localized deformation region 308) can be performed by the touch sensor or processor coupled thereto in order to provide a more precise determination of the direction of the touch force, F_{T}, applied an oblique angle to the touch surface 302.

FIG. 4 shows a non-perpendicular touch force, F_{T}, applied to a touch surface 402 of a touch sensor. Application of the touch force, F_{T}, to the touch surface 402 causes asymmetrical elastic localized deformation 408 at the touch location. Application of the touch force, F_{T}, at an oblique angle to the touch surface 402 creates a localized depression, A, and a localized protrusion, B, of the touch surface 402 at the touch location. The sensor 404 makes measurements to determine the shape or profile of the localized depression, A, and protrusion, B, from which the direction of the non-perpendicular force, F_{T}, can be determined In this illustrative example, the sensor 404 can determine that the localized depression, A, is on the left side of the dashed line relative to the localized protrusion, B, which is opposite of the scenario shown in FIG. 3. Based on the relative locations of the localized depression, A, and protrusion, B, at the touch location, the sensor 404 or processor coupled thereto can determine that the non-perpendicular touch force, F_{T}, is oriented in a direction toward the bottom of the localized depression, A, and away from the peak of the localized protrusion, B. It will be appreciated that the direction of the non-perpendicular touch force, F_{T}, can be resolved by measuring or mapping the contour (e.g., topography) of the localized deformation (208, 308, 408) in three dimensions or in two-dimensional slices.

Referring once again to FIG. 1 and in view of the localized deformation regions 208, 308, and 408 shown in FIGS. 2-4, a touch sensor 100 can be configured to sense localized depression and protrusion of the touch surface 102 at the touch location in response to a non-perpendicular force applied thereto in accordance with various embodiments of the disclosure. A processor 120 can be configured to determine a direction of the non-perpendicular force based on the localized depression and protrusion of the touch surface 102 at the touch location. The processor 120 can be configured to determine a magnitude of the non-perpendicular force applied at the touch location. The processor may also be configured to determine the location of the non-perpendicular force applied at the touch location.

According to various embodiments, the sensor 104 is configured to sense a first force component directed into the touch surface 102 at the touch location and a second force component directed out of the touch surface 102 at the touch location. The processor 120 is configured to determine the direction of the non-perpendicular force using the first and second force components. The localized depression is formed in response to the first force component and the localized protrusion is formed in response to the second force component. The sensor 104 can include a capacitive sensor, a resistive sensor, an optical sensor, a piezoelectric sensor, or a combination of any of these sensors. For example, the touch sensor 100 can include a first type of sensor and a second type of sensor different from the first type of sensor. The processor 120 can be configured to use of output from the first type of sensor to determine the touch location and to use an output of the second type of sensor to determine a magnitude and the direction of the non-perpendicular force, F_{T}.

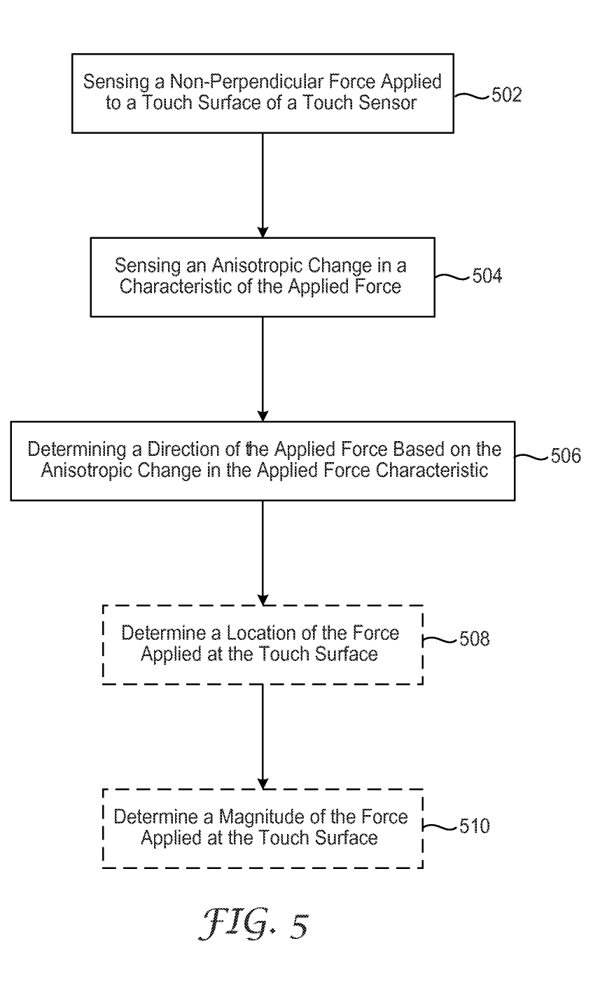

FIG. 5 is a flow chart showing various processes of sensing a touch force by a touch sensor in accordance with various embodiments. The method illustrated in FIG. 5 includes sensing 502 a non-perpendicular force applied to a touch surface of a touch sensor, and sensing 504 and anisotropic change in the characteristic of the applied force. The method also involves determining 506 a direction of the applied force based on the anisotropic change in the applied force characteristic. The method may optionally involve determining 508 a location of the force applied at the touch surface, and may also optionally involve determining 510 a magnitude of the force applied at the touch surface.

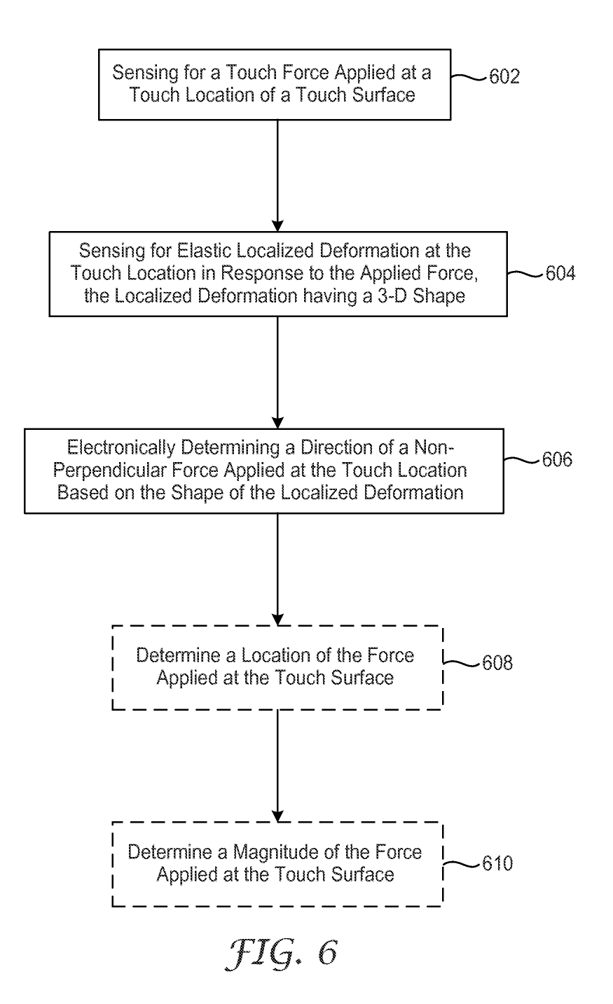

FIG. 6 is a flowchart showing various processes of sensing a touch force by a touch sensor in accordance with other embodiments. The method illustrated in FIG. 6 involves sensing 602 for a touch force applied at a touch location of the touch surface. The method also involves sensing 604 for elastic localized deformation at the touch location in response to the applied force, the localized deformation having a three-dimensional shape. The method further involves electronically determining a direction of a non-perpendicular force applied at the touch location based on the shape of the localized deformation. The method may optionally involve determining 608 a location of the force applied at the touch surface, and may also optionally involve determining 610 a magnitude of the force applied at the touch surface.

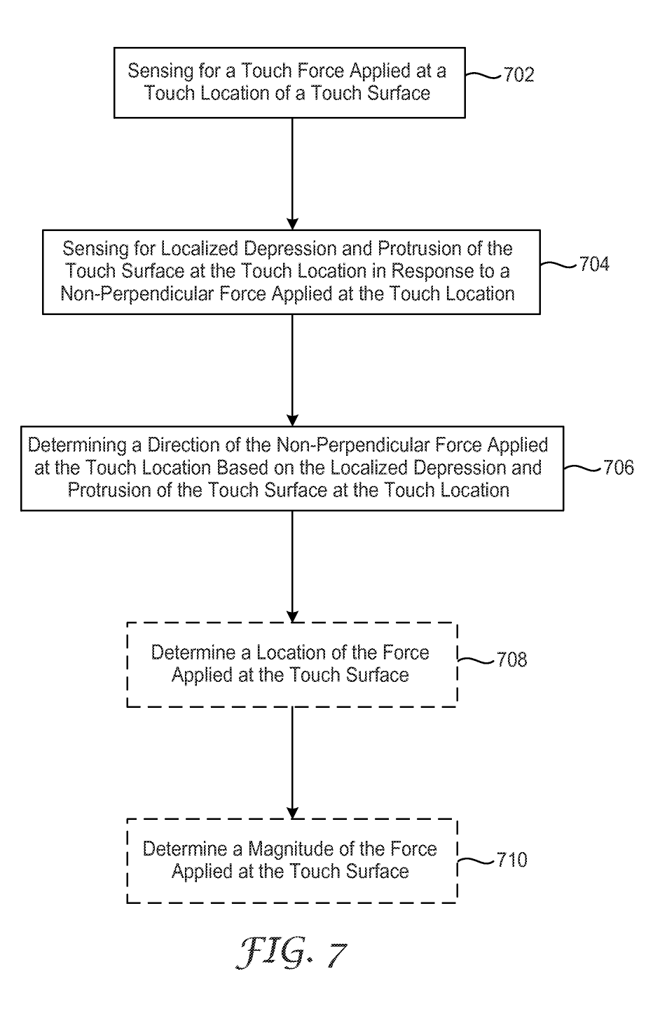

FIG. 7 is a flowchart showing various processes of sensing a touch force by a touch sensor in accordance with various embodiments. The method illustrated in FIG. 7 involves sensing 702 for a touch force applied at a touch location of the touch surface. The method also involves sensing 704 for localized depression and protrusion of the touch surface at the touch location in response to a non-perpendicular force applied at the touch location. The method further involves determining 706 a direction of the non-perpendicular force applied at the touch location based on the localized depression and protrusion of the touch surface at the touch location. The method may optionally involve determining 708 a location of the force applied at the touch surface, and may also optionally involve determining 710 a magnitude of the force applied at the touch surface.

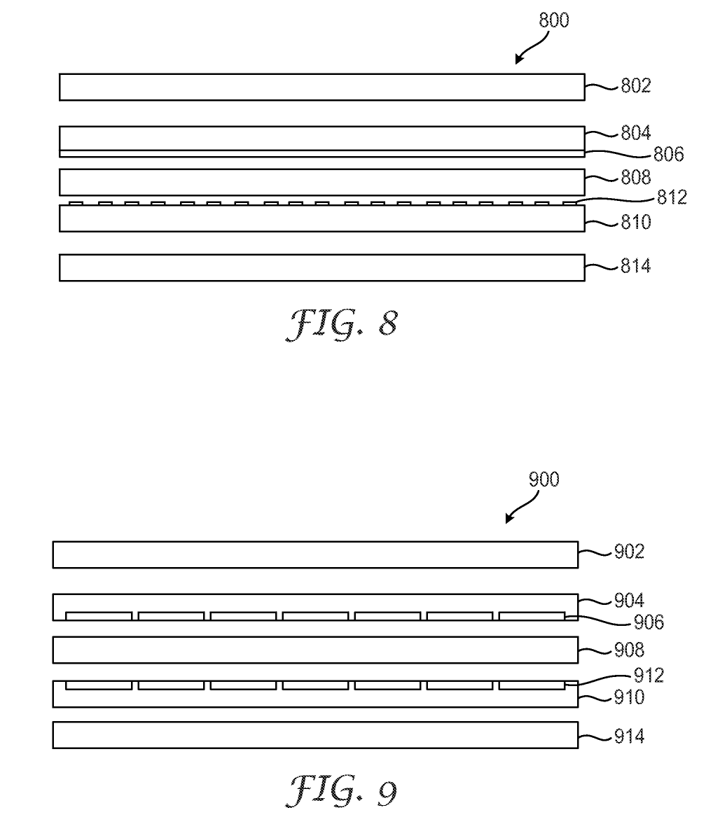

FIG. 8 is a sectional view of a capacitive touch sensor 800 in accordance with various embodiments. The touch sensor 800 includes a first layer 802 of a transparent and elastically deformable material. The touch sensor 800 includes an electrode layer 804 comprising a first set of transparent conductive traces 806 extending along a first direction in a first plane and subject to elastic deformation in response to an applied non-perpendicular force. Adjacent the transparent conductive traces 806 is a second layer 808 of a transparent, elastically deformable material. In some embodiments, the second layer 808 is more flexible or compliant (e.g., has a lower elastic modulus) than the first layer 802. Adjacent the second layer 802 is an electrode layer 810 comprising a second set of transparent conductive traces 812 extending along a second direction in a second plane spaced apart from the first plane. The touch sensor 800 may also include a transparent layer or substrate 814 that supports the second electrode layer 810. In some embodiments, the transparent layer or substrate 814 is an outer surface of a display to which the touch sensor 800 is connected.

A capacitive touch sensor of a type described herein can incorporate features and functions described in U.S. Pat. Nos. 7,148,882 and 7,538,760, and in U.S. Patent Publication Nos. 2002/0149572, 2007/0063876, and 2006/0227114, each of which is incorporated herein by reference. According to some embodiments, the assembly (or sub-assembly thereof) shown in FIG. 8 and other figures defines a deformable substrate assembly which includes an array or arrays of ductile metal conductive traces on a surface thereof. The deformable substrate assembly is connected to other microelectronic components during manufacturing of the touch sensor. When an electronic component is adhesively bonded to the substrate assembly, and bonding elements from a microelectronic component contacts the traces, the substrate can have material properties which allow individual bonding elements to locally deform the traces until the traces penetrate into the substrate surface. Details of a suitable deformable substrate assembly can be found in PCT Publication No. WO 1997008749 A1, which is incorporated herein by reference.

FIG. 9 is a sectional view of a resistive touch sensor 900 in accordance with various embodiments. The touch sensor 900 includes a first layer 902 of a transparent and elastically deformable material. The touch sensor 900 includes first and second resistive pattern layers 904 and 910 separated from one another by a windowed spacer 908. Each of the first and second resistive pattern layers 904 and 910 includes a plurality of patterned electrode elements 906 and 912. The electrode elements 906 and 912 are shown to have a bar shape, but this is by way of example only. The windowed spacer 908 is dimensioned to provide separation between the opposing resistive pattern layers 904 and 910 in the absence of touch forces applied to the first layer 902. The window portion of the windowed spacer 908 allows for contact between the resistive pattern layers 904 and 910 in response deformation of the first layer 909 due to touch forces applied thereto. The touch sensor 900 may also include a transparent layer or substrate 914 that supports the second resistive pattern layer 910. In some embodiments, the transparent layer or substrate 914 is an outer surface of a display to which the touch sensor 800 is connected. Various embodiments of a resistive touch sensor can incorporate features and functions (e.g., multi-point, multi-touch capability) disclosed in U.S. Patent Publication Nos. 2009/0237374 and 2010/0141604, and in U.S. Pat. No. 8,446,388, each of which is incorporated herein by reference.

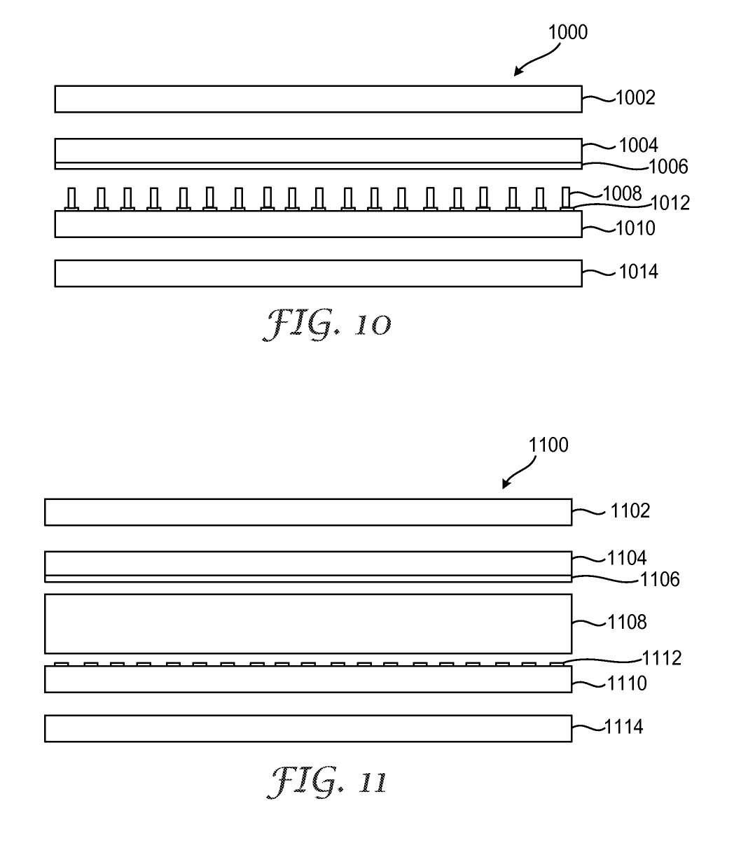

FIG. 10 is a sectional view of a touch sensor 1000 that employs a force sensing material in accordance with various embodiments. The touch sensor 1000 includes a first layer 1002 of an elastically deformable material, and a first electrode layer 1004 comprising a first set of conductive traces 1006 extending along a first direction and subject to elastic deformation in response to a non-perpendicular force. The touch sensor 1000 also includes a second layer 1010 comprising a force sensing material 1008. The second layer 1010 further includes a second set of conductive traces 1012 extending along a second direction, such that the first set of conductive traces 1006 are separated from the second set of conductive traces 1012 by the force sensing material 1008. In some embodiments, the force sensing material 1008 comprises a pressure sensitive membrane that changes resistivity in response to changes in compressive forces acting upon the membrane. The pressure sensitive membrane may, for example, comprise fibrillated polytetrafluoroethylene (PTFE), carbon, and expandable microspheres. In some embodiments, the force sensing material 1008 comprises a force sensitive resistor material. For example, the force sensitive resistor material may comprise a conducting matrix with expandable microspheres. Various embodiments of a touch sensor employing a force sensing material can incorporate features and functions described in U.S. Pat. Nos. 5,209,967; 5,302,936; and 7,260,999; and in U.S. Patent Publication No. 2011/0273394, each of which is incorporated herein by reference.

FIG. 11 is a sectional view of a touch sensor 1100 that employs a piezoelectric polymer material in accordance with various embodiments. The touch sensor 1100 includes a first layer 1102 of a transparent and elastically deformable material, and a first transparent, piezoelectric polymer layer 1104 adjacent the first layer 1102. A first set of transparent conductive traces 1106 is disposed over the first transparent, piezoelectric polymer layer 1104, and extend along a first direction and subject to elastic deformation in response to a non-perpendicular force. The touch sensor 1100 also includes a second transparent, piezoelectric polymer layer 1110. A transparent, polymeric dielectric core 1108 is disposed between the first and second piezoelectric polymer layers 1104 and 1110. A second set of transparent conductive traces 1112 is disposed over the second piezoelectric polymer layer 1110, and extend along a second direction different from the direction of the first set of conductive traces 1106.

In accordance with another embodiment, the touch sensor 1100 shown in FIG. 11 includes a single transparent, piezoelectric polymer layer, such as piezoelectric polymer layer 1104 (e.g., excludes the second transparent, piezoelectric polymer layer, such as piezoelectric polymer layer 1110). In such an embodiment, the second set of transparent conductive traces 1112 is disposed over the second layer of transparent material 1114. In some embodiments, the first and second piezoelectric polymer layers 1104 and 1110 comprise poled polyvinylidene difluoride (PVDF), and the core layer comprises polymethyl methacrylate (PMMA). Various embodiments of a piezoelectric touch sensor can incorporate features and functions disclosed in commonly-owned U.S. Patent Application Ser. No. 61/907,354, filed Nov. 21, 2013, which is incorporated herein by reference. Various embodiments of a piezoelectric touch sensor can incorporate features and functions disclosed in U.S. Patent Publication No. 2009/0309616, which is incorporated herein by reference.

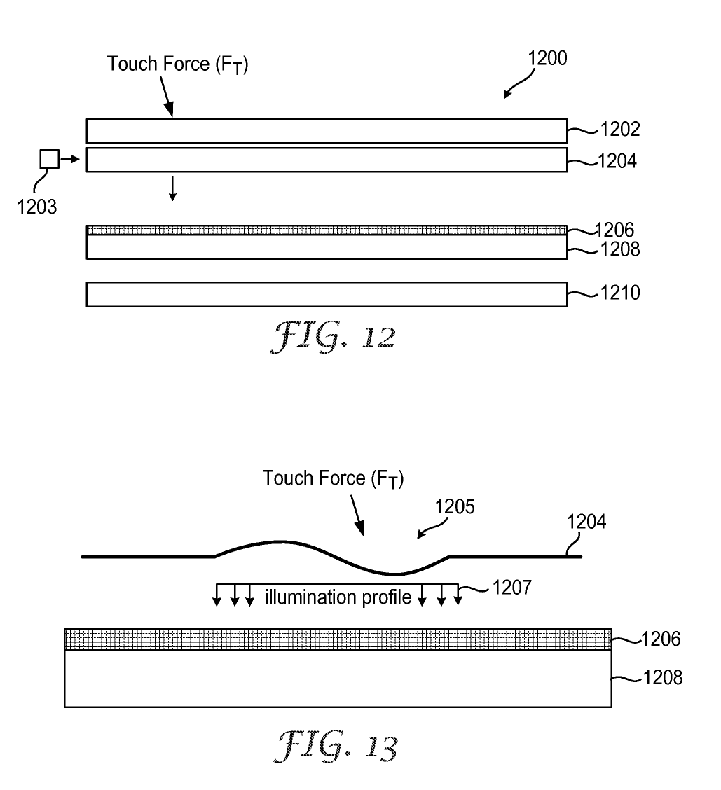

FIG. 12 is a sectional view of a touch sensor 1200 that employs a deformable optical waveguide and frustrated total internal reflection (FTIR) to detect a touch force and a direction of the touch force in accordance with various embodiments. The touch sensor 1200 includes a first layer 1202 of a transparent and elastically deformable material. Adjacent the first layer 1202 is a deformable optical waveguide 1204. In some embodiments, a surface of the deformable optical waveguide 1204 constitutes a touch surface 1202 of the touch sensor 1200. A light source 1203 is configured to direct incident light through a side edge of the waveguide 1204, such that light is contained within the waveguide 1204 via total internal reflection in the absence of deformation of the waveguide 1204. The touch sensor 1200 further includes an optical sensor 1208 configured to sense light emerging from the waveguide 1204 at a location of deformation resulting from a non-perpendicular force applied to the touch surface 1202. In some embodiments, the optical sensor 1208 includes a pixilated optical sensor 1206. In other embodiments, the optical sensor 1208 is a charged coupled device 1206. In certain embodiments, the optical sensor 1208 comprises an array of semiconductor photodetectors 1206. Optionally, the touch sensor 1200 may include a substrate 1210 which serves to support the optical sensor 1208.

Various embodiments of a touch sensor that exploits the FTIR phenomenon for touch force detection can incorporate features and functions disclosed in U.S. Pat. No. 8,441,467, and in U.S. Patent Publication Nos. 2006/0227120 and 2008/0060854, each of which is incorporated herein by reference.

FIG. 13 illustrates a region 1205 of localized elastic deformation of the deformable optical waveguide 1204 in response to application of a touch force, F_{T}. Application of a non-perpendicular touch force, F_{T}, to the waveguide 1204 results in deformation 1205 of the waveguide 1204 in the form of localized depression and protrusion of the waveguide 1204 at the touch location. As a result, light emerges from the waveguide 1204 at a location impacted by the touch force, F_{T}, due to the FTIR phenomenon. Because the waveguide 1204 deforms in a known pattern (e.g., localized depression and protrusion), the light emerging from the waveguide 1204 has an illumination profile 1207 that varies depending on the deformation pattern of the waveguide 1204 at the touch location. This illumination profile 1204 can be detected by the optical sensor 1208 and analyzed by the touch sensor or a processor coupled thereto. Variations in intensity of the illumination profile 1207, for example, can be used to determine the direction of a non-perpendicular touch force, F_{T}, applied to the waveguide 1204.

Embodiments of the disclosure are directed to a touch sensor of a type described hereinabove in combination with a display. In various embodiments, the touch sensor is fabricated with optically transparent layers, allowing the touch sensor to be integrated in front of a display. In other embodiments, the touch sensor is fabricated with one or more opaque layers, and is integrated behind a display. In such embodiments, the display in front of the touch sensor is elastically deformable, such that a touch force (e.g., a non-perpendicular touch force) applied to the surface of the display is coupled to the touch sensor.

According to some embodiments, a touch sensitive display includes a liquid-crystal display (LCD) touch screen that integrates touch sensing elements with the display circuitry. In some implementations, touch sensing elements can be completely implemented within the LCD stack assembly, but outside and not between the color filter plate and the array plate. In other implementations, some touch sensing elements can be disposed between the color filter and array plates with other touch sensing elements being situated elsewhere. In further implementations, all touch sensing elements can be disposed between the color filter and array plates. Various embodiments disclosed herein can incorporate features and functionality described in U.S. Pat. No. 8,243,027, which is incorporated herein by reference.

A touch sensor according to the present disclosure provides for enhanced interaction with virtual objects of a display by using the direction of a touch force as a control input. According to various embodiments, a touch sensor of the disclosure provides for enhanced user control of virtual objects and other aspects of the display based on touch force direction in addition to one or both of touch force magnitude and touch force location. For example, a touch sensor can be configured to display a virtual object, and a processor coupled to the touch sensor can be configured to move the virtual object in a direction based on a direction and a magnitude of a non-perpendicular force applied to the touch sensor. By way of further example, a processor can be configured to move a virtual object presented on the display at a speed based on a direction and a magnitude of a non-perpendicular force applied to the touch sensor.

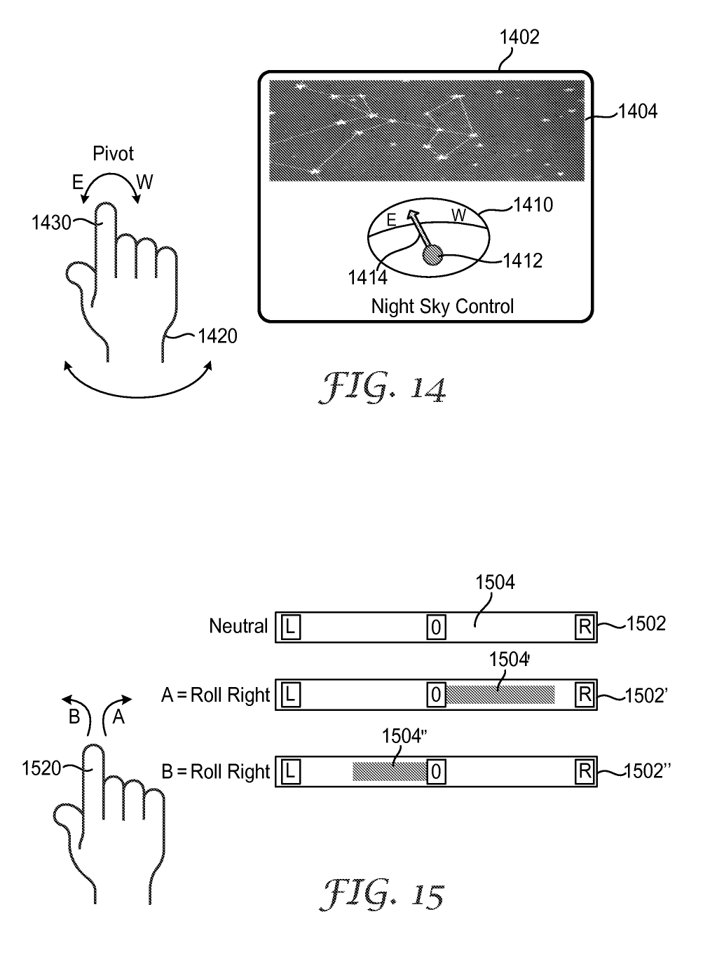

FIG. 14 illustrates virtual objects presented on a touch sensitive display that can be manipulated by a user in accordance with various embodiments. At least one of the virtual objects presented on the display 1402 is controlled based on the direction of a touch force applied to the display 1402. One or more virtual objects presented on the display 1402 can be controlled or manipulated via user interaction with a virtual control 1410. In the representative example shown in FIG. 14, the virtual control 1410 can be manipulated by a user to alter the presentation of an image 1404 presented on the display 1402. More particularly, a region of the night sky is presented as an image 1404 on the display 1402, and actuation of the virtual control 1410 by the user can cause different regions of the night sky to move into and out of the display region of the display 1402.

According to one illustrative example, a user uses his or her finger 1430 to activate the virtual control 1410, such as by tapping on knob 1412. In response to a tap applied to knob 1412, the virtual control 1410 changes in some fashion (e.g., illuminates and/or changes color) to indicate that the virtual control 1410 has been activated for use. The virtual control 1410, when activated, allows the user to pan between east and west directions across the night sky. For example, moving the directional arrow 1414 in an easterly direction causes the night sky image 1404 to pan towards the east. Moving the directional arrow 1414 in a westerly direction causes the night sky image 1404 to pan towards the west. In one approach, the user can place his or her finger 1430 on the directional arrow 1414 and use an arcuate or left-to-right swipe motion to cause the directional arrow 1414 to move between the east and west indicators, E and W, respectively.

Rather than using a swipe gesture to cause the desired movement of the directional arrow 1414 between the east and west indicators, E and W, the desired movement of the directional arrow 1414 can be achieved without significantly translating the position of the user's finger 1430 by using a touch force determination methodology of the present disclosure. As is illustrated in FIG. 14, a user can place his or her finger 1430 at the knob 1412 and alter the touch force applied to the knob 1412 to move the directional arrow 1414 as desired. In one approach, and with the user's finger 1430 placed on the knob 1412, the user pivots his or her hand 1420 left and right well keeping the finger 1430 relatively stationary at the knob 1412. Pivoting the hand 1420 in this manner changes the direction of the touch force applied at the knob 1412, although the location of the touch force remains relatively stationary.

Pivoting the hand 1422 to the right while keeping the finger 1430 on the knob 1412 causes the directional arrow 1414 to move toward the left (e.g., eastwardly direction). Pivoting the hand 1422 to the left while keeping the finger 1430 on the knob 1412 causes the directional arrow 1414 to move toward the right (e.g., westerly direction). As the finger 1430 pivots or rotates about a relatively stationary location of the display (e.g., knob 1412), the touch sensitive display senses changes in the touch force direction and causes a corresponding movement of the directional arrow 1414. In some embodiments, both the change and rate of change in touch force direction are determined This allows the user to control both the direction and rate of change in direction (e.g., speed) of a virtual control and, therefore, the virtual object acted upon by the virtual control.

The virtual control 1410 can be a single mode or multiple mode control. In a single mode of operation, the virtual control 1410 can operate in a manner discussed hereinabove. In a multiple mode of operation, a change in the magnitude of the touch force can be used as an additional user input to enhance control of a virtual object presented on the display 1402. For example, a user can control panning of the night sky between the east and west indicators, E and W, by manipulating the virtual control 1410 in a manner previously discussed. The rate or speed of panning can be controlled by varying the touch force applied to the knob 1412. For example, pressing the finger 1430 lightly against the knob 1412 results in a slow panning action, while increasing pressure applied by the finger 1430 at the knob 1412 results in a progressively faster panning response. In this illustrative example, changes in the magnitude of the touch force correspond to proportional changes in the rate at which the virtual object changes on the display 1402.

FIG. 15 illustrates a virtual control that operates as a slider or fader in accordance with various embodiments. The virtual control 1502 shown in FIG. 15 can be used to adjust the amplitude of sound between left and right speaker channels, for example. The top illustration of the virtual control 1502 indicates a balanced output between left and right channels, as indicated by the absence of coloring or shading within the display region 1504 of the virtual control 1502. In this illustrative example, the virtual control 1502 is manipulated by the user placing his or her finger 1520 at the center or zero location of the control 1502 and rolling the finger 1520 to the left or to the right while keeping the finger 1520 at the zero location. Rolling the finger 1520 the right, for example, results in increasing the right speaker output relative to the left speaker output, as indicated by the coloring or shading within the display region 1504′. Rolling the finger 1522 the left, for example, results in increasing the left speaker output relative to the right speaker at output, as indicated by the coloring or shading within the display region 1504″. Rolling of the finger 1522 to the left and to the right is detected as a change in touch force direction by the touch sensitive display. The virtual control 1504 shown in FIG. 15 can be implemented as a single mode (e.g., direction detected) or a multiple mode control (e.g., direction and rate of change in direction detected).

Various touch sensor embodiments disclosed herein can be implemented to provide a multi-point or multi-touch detection capability. A multi-point touch sensor can be configured to determine locations of multiple touches that may occur simultaneously or substantially simultaneously. According to some embodiments, a multi-point sensing arrangement is capable of simultaneously detecting and monitoring touches and the magnitude and direction of those touches at distinct points across the touch sensitive surface of the touch sensor. The multi-point sensing arrangement can provides a plurality of transparent sensor coordinates or nodes that work independent of one another and that represent different points on the touch sensor. When plural objects are pressed against the touch sensor, one or more sensor coordinates are activated for each touch point. The sensor coordinates associated with each touch point produce respective tracking signals, which are used by a processor to determine the location, magnitude, and direction of each of the simultaneous touches. Various embodiments disclosed herein can incorporate features and functionality described in U.S. Pat. Nos. 8,416,209 and 8,441,467, and in U.S. Patent Publication Nos. 2012/0188189, 2010/0141604, and 2006/0279548, each of which is incorporated herein by reference.

The following are items of the present disclosure:

Item 1 is a touch sensor, comprising:

first and second patterned conductive traces; and

an optically clear layer disposed between the first and second patterned conductive traces, the touch sensor configured to determine a direction of a force applied to the touch sensor by determining an anisotropic change in a characteristic of the applied force.

Item 2 is the touch sensor of item 1, wherein the characteristic of the applied force comprises a contact area between the touch sensor and the applied force.

Item 3 is the touch sensor of item 2, wherein as the force is applied to the touch sensor along a direction oblique to the plane of the sensor, the contact area changes anisotropically along the oblique direction projected onto the touch sensor.

Item 4 is the touch sensor of item 1, wherein the characteristic of the applied force comprises a change in capacitance in the touch sensor proportional to the applied force.

Item 5 is the touch sensor of item 1, wherein as the force is applied to the touch sensor along an oblique direction, capacitances in the sensor increase along the oblique direction projected onto the touch sensor.

Item 6 is the touch sensor of item 1, further configured to determine a magnitude of a force applied to the touch sensor by determining an anisotropic change in a characteristic of the applied force.

Item 7 is the touch sensor of item 1, further configured to determine a direction of a force applied to the touch sensor by determining an anisotropic change in a characteristic of the optically clear layer.

Item 8 is the touch sensor of item 7, wherein the characteristic of the optically clear layer is a local thickness of the layer.

Item 9 is the touch sensor of item 1, further configured to determine a location of the applied force on the touch sensor.

Item 10 is an apparatus, comprising:

a touch sensor having a touch surface, the touch sensor configured to electronically sense for elastic localized deformation at a touch location of the touch surface in response to a force applied thereto, the elastic localized deformation at the touch location having a three-dimensional shape; and

a processor coupled to the touch sensor, the processor configured to electronically determine a direction of a non-perpendicular force applied at the touch location based on the shape of the localized deformation at the touch location.

Item 11 is the apparatus of item 10, wherein the processor is configured to electronically determine a magnitude of the non-perpendicular force applied at the touch location.

Item 12 is the apparatus of item 10, wherein the processor is configured to electronically determine a location of the non-perpendicular force applied at the touch location.

Item 13 is the apparatus of item 10, wherein the elastic localized deformation comprises elastic localized deformation of at least two substantially parallel major surfaces of the touch sensor.

Item 14 is the apparatus of item 10, wherein the elastic localized deformation comprises elastic localized deformation of only one major surface of the touch sensor.

Item 15 is the apparatus of item 10, wherein:

the touch sensor is configured to display a virtual object; and

the processor is configured to move the virtual object in a direction based on a direction and a magnitude of the applied non-perpendicular force, respectively.

Item 16 is the apparatus of item 10, wherein:

the touch sensor is configured to display a virtual object; and

the processor is configured to move the virtual object at a speed based on a direction and a magnitude of the applied non-perpendicular force, respectively.

Item 17 is the apparatus of item 10, wherein the touch sensor comprises a capacitive sensor configured to map the shape of the elastic localized deformation at the touch location.

Item 18 is the apparatus of item 10, wherein the touch sensor comprises a resistive sensor configured to map the shape of the elastic localized deformation at the touch location.

Item 19 is the apparatus of item 10, wherein the touch sensor comprises an optical sensor configured to map the shape of the elastic localized deformation at the touch location.

Item 20 is the apparatus of item 10, wherein the touch sensor comprises a piezoelectric sensor configured to map the shape of the elastic deformation at the touch location.

Item 21 is the apparatus of claim 10, wherein:

the touch sensor is configured to sense a first force component directed into the touch surface at or near the touch location and a second force component directed out of the touch surface at or near the touch location; and

the processor is configured to determine the direction of the non-perpendicular force using the first and second force components.

Item 22 is the apparatus of item 21, wherein the localized deformation is formed in response to the first and second force components.

Item 23 is the apparatus of item 10, wherein the touch sensor comprises:

a first type of sensor and a second type of sensor different from the first type of sensor; and

the processor is configured to use an output from the first type of sensor to determine the touch location and to use an output of the second type of sensor to determine a magnitude and the direction of the non-perpendicular force.

Item 24 is an apparatus, comprising:

a touch sensor having a touch surface, the touch sensor configured to sense localized depression and protrusion of the touch surface at the touch location in response to a non-perpendicular force applied thereto; and

a processor coupled to the touch sensor, the processor configured to determine a direction of the non-perpendicular force based on the localized depression and protrusion of the touch surface at the touch location.

Item 25 is the apparatus of item 24, wherein the processor is configured to electronically determine a magnitude of the non-perpendicular force applied at the touch location.

Item 26 is the apparatus of item 25, wherein the processor is configured to electronically determine a location of the non-perpendicular force applied at the touch location.

Item 27 is the apparatus of item 24, wherein:

the touch sensor is configured to sense a first force component directed into the touch surface at the touch location and a second force component directed out of the touch surface at the touch location; and

the processor is configured to determine the direction of the non-perpendicular force using the first and second force components.

Item 28 is the apparatus of item 27, wherein the localized depression is formed in response to the first force component and the localized protrusion is formed in response to the second force component.

Item 29 is the apparatus of item 24, wherein the elastic localized deformation comprises elastic localized deformation of at least two substantially parallel major surfaces of the touch sensor.

Item 30 is the apparatus of item 24, wherein the elastic localized deformation comprises elastic localized deformation of only one major surface of the touch sensor.

Item 31 is the apparatus of item 24, wherein:

the touch sensor is configured to display a virtual object; and

the processor is configured to move the virtual object in a direction based on a direction and a magnitude of the applied non-perpendicular force, respectively.

Item 32 is the apparatus of claim 24, wherein:

the touch sensor is configured to display a virtual object; and

the processor is configured to move the virtual object at a speed based on a direction and a magnitude of the applied non-perpendicular force, respectively.

Item 33 is the apparatus of item 24, wherein the touch sensor comprises a capacitive sensor.

Item 34 is the apparatus of item 24, wherein the touch sensor comprises a resistive sensor.

Item 35 is the apparatus of item 24, wherein the touch sensor comprises an optical sensor.

Item 36 is the apparatus of item 24, wherein the touch sensor comprises a piezoelectric sensor.

Item 37 is the apparatus of item 24, wherein the touch sensor comprises:

a first type of sensor and a second type of sensor different from the first type of sensor; and

the processor is configured to use an output from the first type of sensor to determine the touch location and to use an output of the second type of sensor to determine a magnitude and the direction of the non-perpendicular force.

Item 38 is the apparatus of item 24, wherein the touch sensor comprises:

a first layer of a transparent, elastically more deformable material;

a first set of transparent conductive traces extending along a first direction in a first plane and adjacent the first layer and subject to elastic deformation in response to the non-perpendicular force;

a second layer of a transparent, elastically less formable material relative to the first layer; and

a second set of transparent conductive traces extending along a second direction in a second plane spaced apart from the first plane;

wherein the localized depression is sensed based primarily on an elastic deformation of the first layer and the localized protrusion is sensed based primarily on an elastic deformation of the second layer.

Item 39 is the apparatus of item 10 or item 24, wherein the touch sensor comprises:

a first layer of a transparent, elastically more deformable material;

a first set of transparent conductive traces extending along a first direction in a first plane and adjacent the first layer and subject to elastic deformation in response to the non-perpendicular force;

a second layer of a transparent, elastically less formable material relative to the first layer; and

a second set of transparent conductive traces extending along a second direction in a second plane spaced apart from the first plane.

Item 40 is the apparatus of item 38, wherein the processor is configured to determine a magnitude and the direction of the non-perpendicular based on the elastic localized deformation of both the first and second layers.

Item 41 is the apparatus of item 39, wherein the first and second sets of traces are separated by a continuous layer of a transparent elastomeric and electrically resistive material.

Item 42 is the apparatus of item 39, wherein the first and second sets of traces are separated by discontinuous segments of a transparent elastomeric and electrically resistive material.

Item 43 is the apparatus of item 42, wherein the discontinuous segments comprise an array of individually addressable pillars having longitudinal axes oriented normal to the first and second layers.

Item 44 is the apparatus of item 42, wherein the discontinuous segments comprise an array of individually addressable dots having longitudinal axes oriented normal to the first and second layers.

Item 45 is the apparatus of item 39, wherein the first and second sets of traces are separated by a continuous layer of a transparent, elastomeric dielectric material.

Item 46 is the apparatus of item 45, wherein the transparent, elastomeric dielectric material comprises silicone.

Item 47 is the apparatus of item 10 or item 24, wherein the touch sensor comprises:

a first layer of an elastically deformable material;

a first set of conductive traces extending along a first direction and subject to elastic deformation in response to the non-perpendicular force;

a second layer of a force sensing material; and a second set of conductive traces extending along

a second direction, the first set of traces separated from the second set of traces by the second layer.

Item 48 is the apparatus of item 47, wherein the force sensing material comprises a pressure sensitive membrane that changes resistivity in response to changes in compressive forces acting on the membrane.

Item 49 is the apparatus of item 48, wherein the pressure sensitive membrane comprises fibrillated PTFE, carbon, and expandable microspheres.

Item 50 is the apparatus of item 47, wherein the force sensing material comprises a force sensitive resistor material.

Item 51 is the apparatus of item 50, wherein the force sensitive resistor material comprises a conducting matrix with expandable microspheres.

Item 52 is the apparatus of item 10 or item 24, wherein the touch sensor comprises:

a first layer of a transparent, elastically deformable material;

a first transparent, piezoelectric polymer layer adjacent the first layer;

a first set of transparent conductive traces disposed over the first piezoelectric polymer layer, the first set of conductive traces extending along a first direction and subject to elastic deformation in response to the non-perpendicular force;

a second transparent, piezoelectric polymer layer;

a transparent, polymeric dielectric core layer between the first and second piezoelectric polymer layers;

a second layer of a transparent material; and

a second set of transparent conductive traces disposed over the second piezoelectric polymer layer, the second set of conductive traces extending along a second direction different from the direction of the first set of conductive traces.

Item 53 is the apparatus of item 10 or item 24, wherein the touch sensor comprises:

a first layer of a transparent, elastically deformable material;

a transparent, piezoelectric polymer layer adjacent the first layer;

a first set of transparent conductive traces disposed over the first piezoelectric polymer layer, the first set of conductive traces extending along a first direction and subject to elastic deformation in response to the non-perpendicular force;

a second layer of a transparent material;

a transparent, polymeric dielectric core layer between the piezoelectric polymer layer and the second layer; and

a second set of transparent conductive traces disposed over the second piezoelectric polymer layer, the second set of conductive traces extending along a second direction different from the direction of the first set of conductive traces.

Item 54 is the apparatus of item 52 or item 53, wherein the first and second piezoelectric polymer layers comprise poled polyvinylidene difluoride (PVDF).

Item 55 is the apparatus of item 52 or item 53, wherein the core layer comprises polymethyl methacrylate (PMMA).

Item 56 is the apparatus of item 10 or item 24, wherein:

the touch surface comprises a deformable optical waveguide; and

the touch sensor comprises:
a light source arranged to direct light through a side edge of the waveguide, such that light is contained within the waveguide via total internal reflection in the absence of deformation of the waveguide; and
an optical sensor configured to sense light emerging from the waveguide at a location of deformation resulting from the non-perpendicular force.

Item 57 is the apparatus of item 56, wherein the optical sensor is a pixilated optical sensor.

Item 58 is the apparatus of item 56, wherein the optical sensor is charge coupled device.

Item 59 is the apparatus of item 56, wherein the optical sensor comprises an array of semiconductor photodetectors.

Item 60 is the apparatus according to any of items 1 to 59, wherein the processor is configured to determine a location, magnitude, and direction of each of a plurality of non-perpendicular forces concurrently applied at a plurality of touch surface locations.

Item 61 is a system comprising a display and the apparatus according to any of items 1 to 59.

Item 62 is a mobile personal device comprising the apparatus according to any of items 1 to 59.

Item 63 is a computer comprising the apparatus according to any of items 1 to 59.

Item 64 is a tablet comprising the apparatus according to any of items 1 to 59.

Item 65 is a notebook comprising the apparatus according to any of items 1 to 59.

Item 66 is a mobile communication device comprising the apparatus according to any of items 1 to 59.

Item 67 is a mobile phone comprising the apparatus according to any of items 1 to 59.

Item 68 is a smart phone comprising the apparatus according to any of items 1 to 59.

Item 69 is a portable electronic system comprising the apparatus according to any of items 1 to 59.

Item 70 is a method, comprising:

sensing a non-perpendicular force applied to a touch surface of a touch sensor;

sensing an anisotropic change in a characteristic of the applied force; and

determining a direction of the applied force based on the anisotropic change in the applied force characteristic.

Item 71 is a method, comprising:

sensing for a touch force applied at a touch location on a touch surface of a touch sensor;

sensing for elastic localized deformation at the touch location in response to the applied force, the localized deformation having a 3-dimensional shape; and

electronically determining a direction of a non-perpendicular force applied at the touch location based on the shape of the localized deformation.

Item 72 is a method, comprising:

sensing for a touch force applied at a touch location on a touch surface of a touch sensor;

sensing for localized depression and protrusion of the touch surface at the touch location in response to a non-perpendicular force applied at the touch location; and

determining a direction of the non-perpendicular force applied at the touch location based on the localized depression and protrusion of the touch surface at the touch location.

Item 73 is a method according to any of items 70 to 72, further comprising determining a magnitude of the force applied at the touch surface.

Item 74 is a method according to any of items 70 to 73, further comprising determining a location of the force applied at the touch surface.

Various modifications and alterations of the embodiments disclosed herein will be apparent to those skilled in the art. For example, the reader should assume that features of one disclosed embodiment can also be applied to all other disclosed embodiments unless otherwise indicated.

1. A touch sensor, comprising:
first and second patterned conductive traces; and
an optically clear layer disposed between the first and second patterned conductive traces, the touch sensor configured to determine a direction of a force applied to the touch sensor by determining an anisotropic change in a characteristic of the applied force.

2. The touch sensor of claim 1, wherein the characteristic of the applied force comprises a contact area between the touch sensor and the applied force.

3. The touch sensor of claim 2, wherein as the force is applied to the touch sensor along a direction oblique to the plane of the sensor, the contact area changes anisotropically along the oblique direction projected onto the touch sensor.

4. (canceled)

5. The touch sensor of claim 1, further configured to determine a direction of a force applied to the touch sensor by determining an anisotropic change in a characteristic of the optically clear layer.

6. An apparatus, comprising:
a touch sensor having a touch surface, the touch sensor configured to electronically sense for elastic localized deformation at a touch location of the touch surface in response to a force applied thereto, the elastic localized deformation at the touch location having a three-dimensional shape; and
a processor coupled to the touch sensor, the processor configured to electronically determine a direction of a non-perpendicular force applied at the touch location based on the shape of the localized deformation at the touch location.

7. The apparatus of claim 6, wherein the elastic localized deformation comprises elastic localized deformation of at least two substantially parallel major surfaces of the touch sensor.

8-10. (canceled)

11. The touch sensor of claim 1, wherein the characteristic of the applied force comprises a change in capacitance in the touch sensor proportional to the applied force.

12. The touch sensor of claim 1, wherein as the force is applied to the touch sensor along an oblique direction, capacitances in the sensor increase along the oblique direction projected onto the touch sensor.

13. The touch sensor of claim 5, wherein the characteristic of the optically clear layer is a local thickness of the layer.

14. The apparatus of claim 6, wherein the processor is configured to electronically determine a magnitude of the non-perpendicular force applied at the touch location.

15. The apparatus of claim 6, wherein the processor is configured to electronically determine a location of the non-perpendicular force applied at the touch location.

16. The apparatus of claim 6, wherein the elastic localized deformation comprises elastic localized deformation of only one major surface of the touch sensor.

17. The apparatus of claim 6, wherein the touch sensor comprises:
a first type of sensor and a second type of sensor different from the first type of sensor; and
the processor is configured to use an output from the first type of sensor to determine the touch location and to use an output of the second type of sensor to determine a magnitude and the direction of the non-perpendicular force.

18. An apparatus, comprising:
a touch sensor having a touch surface, the touch sensor configured to sense localized depression and protrusion of the touch surface at the touch location in response to a non-perpendicular force applied thereto; and
a processor coupled to the touch sensor, the processor configured to determine a direction of the non-perpendicular force based on the localized depression and protrusion of the touch surface at the touch location.

19. The apparatus of claim 18, wherein the processor is configured to electronically determine a magnitude of the non-perpendicular force applied at the touch location.

20. The apparatus of claim 19, wherein the processor is configured to electronically determine a location of the non-perpendicular force applied at the touch location.

21. The apparatus of claim 18, wherein:
the touch sensor is configured to sense a first force component directed into the touch surface at the touch location and a second force component directed out of the touch surface at the touch location; and
the processor is configured to determine the direction of the non-perpendicular force using the first and second force components.

22. The apparatus of claim 21, wherein the localized depression is formed in response to the first force component and the localized protrusion is formed in response to the second force component.

23. The apparatus of claim 18, wherein the elastic localized deformation comprises elastic localized deformation of at least two substantially parallel major surfaces of the touch sensor.

24. The apparatus of claim 18, wherein the elastic localized deformation comprises elastic localized deformation of only one major surface of the touch sensor.

25. The apparatus of claim 18, wherein the touch sensor comprises:
a first layer of a transparent, elastically more deformable material;
a first set of transparent conductive traces extending along a first direction in a first plane and adjacent the first layer and subject to elastic deformation in response to the non-perpendicular force;
a second layer of a transparent, elastically less formable material relative to the first layer; and
a second set of transparent conductive traces extending along a second direction in a second plane spaced apart from the first plane;
wherein the localized depression is sensed based primarily on an elastic deformation of the first layer and the localized protrusion is sensed based primarily on an elastic deformation of the second layer.

26. The apparatus of claim 18, wherein the touch sensor comprises:
a first layer of a transparent, elastically deformable material;
a first transparent, piezoelectric polymer layer adjacent the first layer;
a first set of transparent conductive traces disposed over the first piezoelectric polymer layer, the first set of conductive traces extending along a first direction and subject to elastic deformation in response to the non-perpendicular force;
a second transparent, piezoelectric polymer layer;
a transparent, polymeric dielectric core layer between the first and second piezoelectric polymer layers;
a second layer of a transparent material; and
a second set of transparent conductive traces disposed over the second piezoelectric polymer layer, the second set of conductive traces extending along a second direction different from the direction of the first set of conductive traces.

27. The apparatus of claim 18, wherein the touch sensor comprises:
a first layer of a transparent, elastically deformable material;
a transparent, piezoelectric polymer layer adjacent the first layer;
a first set of transparent conductive traces disposed over the first piezoelectric polymer layer, the first set of conductive traces extending along a first direction and subject to elastic deformation in response to the non-perpendicular force;
a second layer of a transparent material;
a transparent, polymeric dielectric core layer between the piezoelectric polymer layer and the second layer; and
a second set of transparent conductive traces disposed over the second piezoelectric polymer layer, the second set of conductive traces extending along a second direction different from the direction of the first set of conductive traces.

28. A method, comprising:
sensing a non-perpendicular force applied to a touch surface of a touch sensor;
sensing an anisotropic change in a characteristic of the applied force; and
determining a direction of the applied force based on the anisotropic change in the applied force characteristic.

29. A method, comprising:
sensing for a touch force applied at a touch location on a touch surface of a touch sensor;
sensing for elastic localized deformation at the touch location in response to the applied force, the localized deformation having a 3-dimensional shape; and
electronically determining a direction of a non-perpendicular force applied at the touch location based on the shape of the localized deformation.

30. A method, comprising:
sensing for a touch force applied at a touch location on a touch surface of a touch sensor;
sensing for localized depression and protrusion of the touch surface at the touch location in response to a non-perpendicular force applied at the touch location; and
determining a direction of the non-perpendicular force applied at the touch location based on the localized depression and protrusion of the touch surface at the touch location.
